(19) United States
(12) Patent Application Publication
(10) Pub. No.: US 2026/0349802 A1
(43) Pub. Date: Nov. 5, 2026

(54) METHOD AND SYSTEM FOR DYNAMICALLY MANAGING COMPUTING RESOURCE LOCKING

(71) Applicant: HCL Technologies Italy S.p.A., Vimodrone (IT)

(72) Inventors: Longobardi Giuseppe, Rome (IT); Baglioni Cecilia, Rome (IT); Cascioli Valerio, Rome (IT); D’amore Grazia, Rome (IT); Falsi paolo, Rome (IT); Iezzi Alessandro, Rome (IT); Montervino Dario, Rome (IT); Tondi Danilo, Rome (IT)

(21) Appl. No.: 19/193,974

(22) Filed: Apr. 30, 2025

(51) Int. Cl. G06F 9/50

(52) U.S. Cl. CPC G06F 9/5027

(57) ABSTRACT

Disclosed herein, method and system for dynamically managing computing resource locking. The method may include identifying a task queue for a computing resource while executing a current task. Upon identifying the task queue, the method may include generating a set of chunks from the current task based on a predefined criterion. The method may further include executing, using the computing resource a current chunk from the set of chunks. The method may further include queuing remaining of the set of chunks for execution using the computing resource after a last task of the task queue upon initiating the execution of the current chunk. The method may further include monitoring a re-queue time of a next chunk from the remaining set of chunks.

### DETAILED DESCRIPTION

### Technical Field

This disclosure generally relates to resource locking. More particularly, the disclosure relates to a method and a system for dynamically managing computing resource locking.

### Background

Mostly, in operating systems a synchronization tool is used to manage access to a shared resource (or a computing resource). A concurrent access to the shared resource is protected by using a resource lock (e.g., semaphore) to achieve process synchronization. A task in need of the shared resource is added to a waiting queue in case the shared resource is already in use. The task acquires the resource lock in case the shared resource is available and hold it until the task performs an activity. Once the activity is performed the task releases the resource lock and a first task waiting in a queue acquires the resource lock.

Once the resource lock is acquired, the task may keep the resource lock until all the activities are performed. But the longer the resource lock is held by the task, the longer a remaining tasks in the queue need to wait. For example, a task needing the computing resource for just 1 second, to complete its activities, may be required to wait for a preceding task which obtained the resource lock before, and held the resource lock for 2 minutes before releasing it. This may not be optimal.

In the existing technologies, once the resource lock is granted, a resource lock lease period associated with the resource lock is determined. However, the existing technologies fail to optimize the resource lock lease period. There is, therefore, a need for techniques to optimize the waiting time for the tasks in the queue for execution via the shared resource.

### SUMMARY

In one embodiment, a method for dynamically managing computing resource locking is disclosed. The method may include identifying a task queue for a computing resource while executing a current task. The computing resource may be in a locked state while the current task is executed. The task queue may include a set of tasks queued for execution using the computing resource. Upon identifying the task queue, the method may include generating a set of chunks from the current task based on a predefined criterion. Each of the set of chunks may include a set of executable activities. The method may further include executing, using the computing resource, a current chunk from the set of chunks. The method may further include queuing remaining of the set of chunks for execution using the computing resource after a last task of the task queue upon initiating the execution of the current chunk. The method may further include monitoring a re-queue time of a next chunk from the remaining set of chunks. The re-queue time may be a time interval between completion of execution of the current chunk and initiation of execution of the next chunk.

In another embodiment, a system for dynamically managing computing resource locking is disclosed. The system may include a processor, and a computer-readable medium communicatively coupled to the processor. The computer-readable medium may store processor-executable instructions, which, on execution, may cause the processor to identify a task queue for a computing resource while executing a current task. The computing resource may be in a locked state while the current task is executed. The task queue may include a set of tasks queued for execution using the computing resource. Upon identifying the task queue, the stored processor-executable instructions, on execution, may further cause the processor to generate a set of chunks from the current task based on a predefined criterion. Each of the set of chunks may include a set of executable activities. The stored processor-executable instructions, on execution, may further cause the processor to execute, using the computing resource, a current chunk from the set of chunks. The stored processor-executable instructions, on execution, may further cause the processor to queue remaining of the set of chunks for execution using the computing resource after a last task of the task queue upon initiating the execution of the current chunk. The stored processor-executable instructions, on execution, may further cause the processor to monitor a re-queue time of a next chunk from the remaining set of chunks. The re-queue time may be a time interval between completion of execution of the current chunk and initiation of execution of the next chunk.

In yet another embodiment, a non-transitory computer-readable medium storing computer-executable instructions for dynamically managing computing resource locking is disclosed. The stored instructions, when executed by a processor, may cause the processor to perform operations including identifying a task queue for a computing resource while executing a current task. The computing resource may be in a locked state while the current task is executed. The task queue may include a set of tasks queued for execution using the computing resource. Upon identifying the task queue, the operations may further include generating a set of chunks from the current task based on a predefined criterion. Each of the set of chunks may include a set of executable activities. The operations may further include executing, using the computing resource, a current chunk from the set of chunks and queuing remaining of the set of chunks for execution using the computing resource after a last task of the task queue upon initiating the execution of the current chunk. The operations may further include monitoring a re-queue time of a next chunk from the remaining set of chunks. The re-queue time may be a time interval between completion of execution of the current chunk and initiation of execution of the next chunk.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for dynamically managing computing resource locking, in accordance with some embodiments of the present disclosure.

FIG. 2 illustrates a functional block diagram of an exemplary system for dynamically managing computing resource locking, in accordance with some embodiments of the present disclosure.

FIG. 3 illustrates a flow diagram of an exemplary method for dynamically managing computing resource locking, in accordance with some embodiments of the present disclosure.

FIG. 4 illustrates a flow diagram of an exemplary method for generating chunks from a task, in accordance with some embodiments of the present disclosure.

FIG. 5 illustrates a flow diagram of an exemplary method for monitoring a re-queue time of chunks of a task, in accordance with some embodiments of the present disclosure.

FIG. 6 illustrates a flow diagram of an exemplary method for modifying chunks of a task, in accordance with some embodiments of the present disclosure.

FIG. 7 illustrates a flow diagram of a detailed exemplary method for dynamically managing computing resource locking, in accordance with some embodiments of the present disclosure.

FIG. 8 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

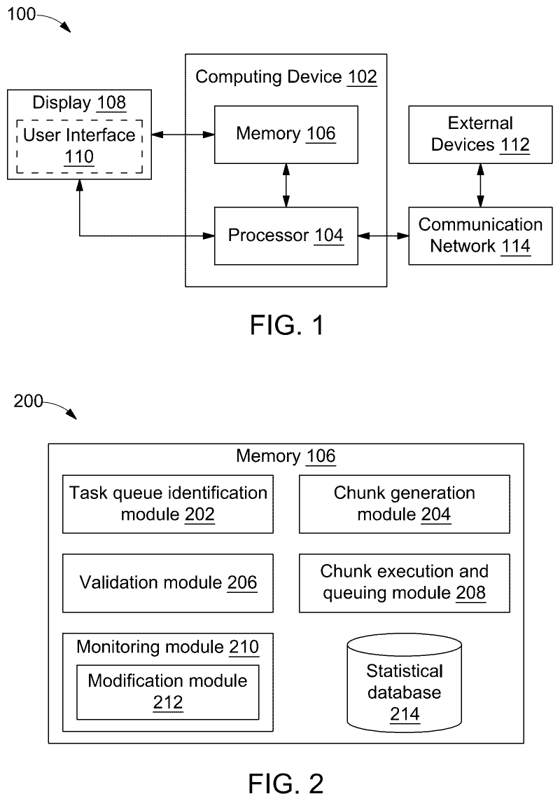

Referring now to FIG. 1, a block diagram of an exemplary system 100 for dynamically managing computing resource locking is illustrated, in accordance with some embodiments of the present disclosure. The system 100 may include a computing device 102, which, for example, may be, but is not limited to a server, a desktop, a laptop, a notebook, a netbook, a tablet, a smartphone, a mobile phone, or any other computing device. The computing device 102 may implement a plurality of processes. The implementation of a plurality of processes may require execution of a plurality of tasks. Additionally, one or more of the plurality of tasks may require access (i.e., read and/or write access) to one or more computing resources (or programming resources). A computing resource may be a shared resource, for example, data (such as, data structure, variable, main memory area, I/O unit, a common buffer between two communicating tasks, or the like). Concurrent access to the computing resource may be protected via a resource lock (e.g., semaphore), when the computing resource is accessed by a task. In other words, the computing resource may be accessed by one task at a time. Remaining tasks may be added to a task queue. The computing device 102 may be configured to dynamically manage computing resource locking for efficiently executing tasks in the task queue.

As will be described in greater detail in conjunction with FIG. 2-8, the computing device 102 may identify a task queue for the computing resource while executing the current task. The computing resource may be in a locked state while the current task is executed. The task queue may include the set of tasks queued for execution using the computing resource. Upon identifying the task queue, the computing device 102 may generate a set of chunks from the current task based on a predefined criterion. Each of the set of chunks may include a set of executable activities. The computing device 102 may then execute, using the computing resource, the current chunk from the set of chunks. The computing device 102 may also queue remaining of the set of chunks for execution using the computing resource after a last task of the task queue upon initiating the execution of the current chunk. The computing device 102 may then monitor the re-queue time of the next chunk from the remaining set of chunks. The re-queue time is a time interval between completion of execution of the current chunk and initiation of execution of the next chunk.

Further, the computing device 102 may include a processor 104 and a memory 106. In one embodiment, the computing resource may be the processor 104. The memory 106 may store instructions that, when executed by the processor 104, cause the processor 104 to dynamically manage computing resource locking, in accordance with aspects of the present disclosure. The memory 106 may also store various data (for example, the task queue, the current task, a deadline execution time associated with the current task, the set of chunks, the current chunk, the next chunk, a predefined threshold execution time, a predefined threshold number of tasks in the task queue and the like) that may be captured, processed, and/or required by the system 100.

The computing device 102 may further include a display 108. A user may interact with the computing device 102 via a user interface 110 accessible via the display 108. The system 100 may also include one or more external devices 112 and the computing device 102 may interact with the one or more external devices 112 over a communication network 114 for sending or receiving various data. The communication network 114, for example, may include, but may not be limited to, a Wireless Fidelity (Wi-Fi) network, a Light Fidelity (Li-Fi) network, a Local Area Network (LAN), a Wide Area Network (WAN), a Metropolitan Area Network (MAN), a satellite network, the internet, a fiber optic network, a coaxial cable network, an infrared (IR) network, a Radio Frequency (RF) network, or a combination thereof. The one or more external devices 112 may include, but may not be limited to a remote server, a laptop, a netbook, a notebook, a smartphone, a mobile phone, a tablet, or any other computing device.

Referring now to FIG. 2, a functional block diagram of an exemplary system 200 for dynamically managing computing resource locking is illustrated, in accordance with some embodiments of the present disclosure. FIG. 2 is explained in conjunction with FIG. 1. The system 200 may be analogous to the system 100. The system 200 may include, within the memory 106, a task queue identification module 202, a chunk generation module 204, a validation module 206, a chunk execution and queuing module 208, and a monitoring module 210. The monitoring module 210 may further include a modification module 212. The memory 106 may also include a statistical database 214.

The task queue identification module 202 may identify a task queue for a computing resource while executing a current task. In other words, the task queue identification module 202 may continuously check for a presence of a task queue for the computing resource. The task queue may include a set of tasks queued for execution via the computing resource. The computing resource may be in a locked state while the current task is executed. In other words, the current task may acquire a resource lock (for example, a semaphore) for the computing resource for execution. The resource lock may prevent the intervention by a next task in the task queue for the computing resource when the current task is executed.

Upon completion of execution of the current task, the resource lock for the computing resource may be released for the next task to access the computing resource. When a task queue is not identified (i.e., no other task is queued for accessing the computing resource), execution of the current task may be continued. In other words, in an absence of a task queue, the resource lock may continue to be held by the current task.

When the task queue is identified, the validation module 206 may validate a predefined criterion for the current task. Further, based on a successful validation of the predefined criterion, the chunk generation module 204 may generate the set of chunks from the current task. Each of the set of chunks may include a set of executable activities. In other words, the task may be considered as one unique “big” activity (for example, the current task) that may be divided into a number of smaller executable activities (analogous to the set of executable activities). An executable activity may include a sequence of steps. Thus, a set of executable activities together may be constitute a chunk, and a set of chunks may constitute a task.

The predefined criterion may be stored in the statistical database 214 and may include at least one of a predefined threshold execution time, a deadline execution time, or a predefined threshold number of tasks in the task queue. The predefined threshold execution time may set forth a time limit for which a task may hold and use the computing resource for execution for one instance. The deadline execution time may be a time limit for execution associated with a particular task. The predefined threshold number of tasks in the task queue may be an upper limit of the number of tasks in the task queue that may prompt the generation of the set of chunks.

In particular, to generate the set of chunks from the current task, the validation module 206 may receive at least one of an execution time of the current task or a deadline associated with the current task from the statistical database 214. The validation module 206 may then validate the execution of the current task based on the predefined criterion. In an embodiment, to validate the execution, the validation module 206 may compare the execution time of the current task with at least one of the predefined threshold execution time or the deadline execution time associated with the current task. In an additional embodiment, to validate the execution, the validation module 206 may compare a number of the set of tasks in the task queue with the predefined threshold number of tasks.

Upon successful validation of the execution of the current task, the chunk generation module 204 may generate the set of chunks from the current task. In one case, the validation may be successful when the execution time associated with the current task may exceed or reach the predefined threshold execution time or the deadline execution time. In another case, the validation may be successful when the number of tasks in the task queue may exceed or reach the predefined threshold number of tasks.

Additionally, the validation module 206 may block the generation of the set of chunks upon one of unsuccessfully validating the execution of the current task or unsuccessfully identifying the task queue. In other words, the chunk generation module 204 may not generate the set of chunks in case the execution time of the current task is less than the predefined threshold execution time and the deadline execution time, or in case no task is present in the task queue. As already explained above, the case when the task queue is empty (or not identified), the set of chunks may not be generated to prevent wastage of time. In such scenarios (i.e., when the set of chunks are not generated), the current task may be executed entirely in one go without any chunking.

Upon generating the set of chunks, the chunk execution and queuing module 208 may execute the current chunk from the set of chunks using the computing resource. Upon initiating the execution of the current chunk, the chunk execution and queuing module 208 may also queue the remaining of the set of chunks for execution using the computing resource after a last task of the task queue. Once the current chunk is executed, the computing resource may be unlocked to initiate an execution of the next task in the task queue using the computing resource. It should be noted that the next task(s) may also undergo a similar validation process by the validation module 206 as described above in detail. In case of successful validation, the chunk generation module 204 may generate a set of chunks for the next task(s) as well. In case of unsuccessful validation, the next task(s) may be executed entirely in one go.

Upon queuing the remaining of the set of chunks at the end of the queue, the monitoring module 210 may monitor a re-queue time of a next chunk from the remaining set of chunks. The re-queue time may be a time interval between completion of execution of the current chunk and initiation of execution of the next chunk. More precisely, the re-queue time may be the time from when the resource lock is released by the current chunk, to when the resource lock is obtained by the next chunk. Further, the validation module 206 may validate the re-queue time of the next chunk based on a threshold re-queue time. In an embodiment, the threshold re-queue time may be based on a current average re-queue time of executed chunks from the set of chunks of the current task. In other words, the re-queue time associated with the next chunk may be compared to the average re-queue time of the executed chunks from the set of chunks of the current task.

Based on the result of the comparison by the validation module 206, the modification module 212 may dynamically modify a number of the remaining of the set of chunks. The modification module 212 may decrease or increase the number of the remaining of the set of chunks based on the validation. In one embodiment, the modification module 212 may decrease the number of the remaining set of chunks when the re-queue time may be less than the threshold re-queue time. In another embodiment, the modification module 212 may increase the number of the remaining set of chunks when the re-queue time may be greater than the threshold re-queue time.

To modify the number of the remaining set of chunks a number of the set of executable activities may be changed based on the validation of the re-queue time. In other words, for each chunk of the remaining of the set of chunks a number of the set of executable activities in the chunk may be modified upon unsuccessful validation of the re-queue time. The modification module 212 may decrease the number of the set of executable activities to increase the number of the remaining of the set of chunks or may increase the number of the set of executable activities to decrease the number of the remaining of the set of chunks.

It should be noted that all such aforementioned modules 202-212 may be represented as a single module or a combination of different modules. Further, as will be appreciated by those skilled in the art, each of the modules 202-212 may reside, in whole or in parts, on one device or multiple devices in communication with each other. In some embodiments, each of the modules 202-212 may be implemented as dedicated hardware circuit comprising custom application-specific integrated circuit (ASIC) or gate arrays, off-the-shelf semiconductors such as logic chips, transistors, or other discrete components. Each of the modules 202-212 may also be implemented in a programmable hardware device such as a field programmable gate array (FPGA), programmable array logic, programmable logic device, and so forth. Alternatively, each of the modules 202-212 may be implemented in software for execution by various types of processors (e.g., the processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module, and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for dynamically managing computing resource locking. For example, the exemplary system 100 and the associated computing device 102, may dynamically manage computing resource locking by the processes discussed herein. In particular, as will be appreciated by those of ordinary skill in the art, control logic and/or automated routines for performing the techniques and steps described herein may be implemented by the system 100 and the associated computing device 102, either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

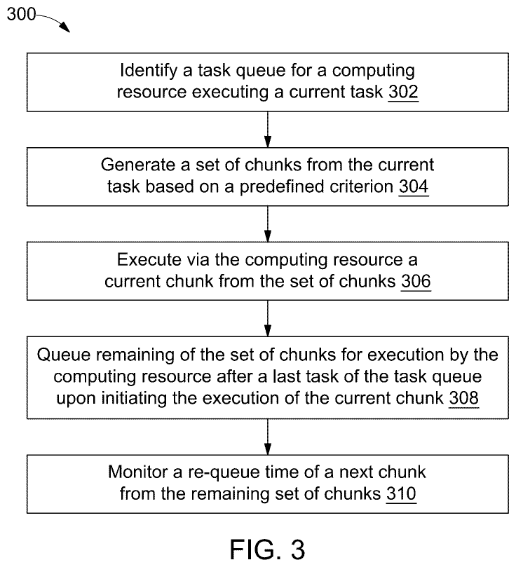

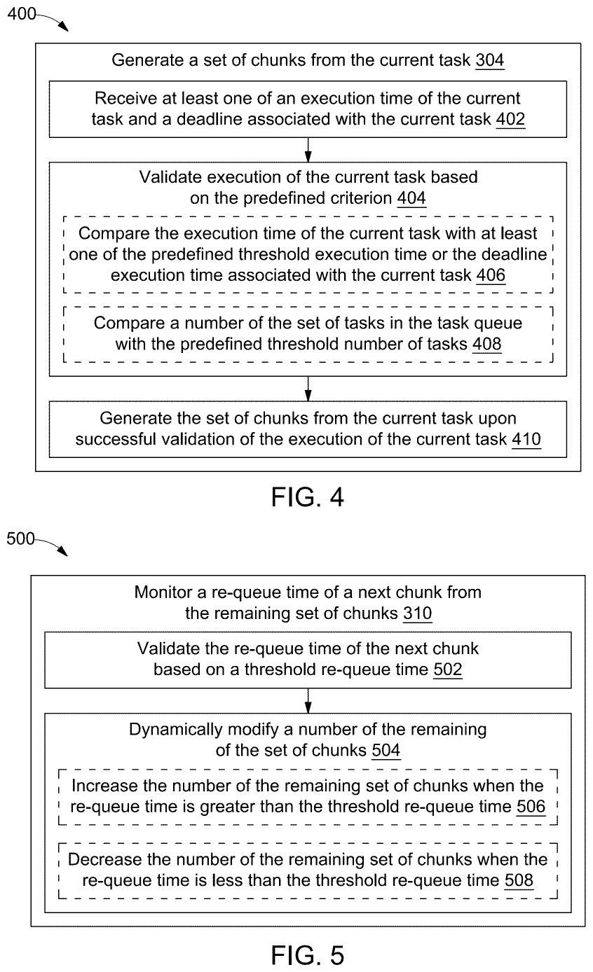

Referring now to FIG. 3, a flow diagram of an exemplary method 300 for dynamically managing computing resource locking is illustrated, in accordance with some embodiments of the present disclosure. The method 300 may be implemented by the computing device 102 of the system 100. The method 300 may include identifying, by the task queue identification module 202, a task queue for a computing resource executing a current task, at step 302. Upon identifying the task queue, the method 300 may include generating a set of chunks from the current task based on a predefined criterion, at step 304. This is explained in greater detail in conjunction with FIG. 4.

Upon receiving the set of chunks, the method 300 may include executing a current chunk from the set of chunks via the computing resource, at step 306. The chunk execution and queuing module 208 may be configured to execute the current chunk from the set of chunks. Upon executing the current chunk, the chunk execution and queuing module 208 may unlock the computing resource to initiate an execution of a next task in the task queue via the computing resource. Further, the method 300 may include queuing, by the chunk execution and queuing module 208, remaining of the set of chunks for execution using the computing resource after a last task of the task queue upon initiating the execution of the current chunk, at step 308.

The method 300 may further include monitoring, by the monitoring module 210, a re-queue time of a next chunk from the remaining set of chunks, at step 310. The re-queue time may be a time interval between completion of execution of the current chunk and initiation of execution of the next chunk. This is explained in greater detail in conjunction with FIG. 5.

Referring now to FIG. 4, an exemplary method 400 for generating chunks from a task is depicted via a flowchart, in accordance with some embodiments of the present disclosure. The method 400 may include receiving, by the validation module 206, at least one of an execution time of the current task and a deadline associated with the current task, at step 402. Upon receiving, the method 400 may include validating, by the validation module 206, execution of the current task based on the predefined criterion, at step 404. In an embodiment, the method 400 may further include comparing, by the validation module 206, the execution time of the current task with at least one of the predefined threshold execution time or the deadline execution time associated with the current task, at step 406. In an additional embodiment, the method 400 may include comparing, by the validation module 206, a number of the set of tasks in the task queue with the predefined threshold number of tasks, at step 408. Upon comparison, the method 400 may include generating, by the validation module 206, the set of chunks from the current task upon successful validation of the execution of the current task, at step 410. In some embodiments, the method 400 may include blocking, by the validation module 206, the generating of the set of chunks upon, one of unsuccessfully validating the execution of the current task, or unsuccessfully identifying the task queue.

Referring now to FIG. 5, an exemplary method 500 for monitoring a re-queue time of chunks of a task is depicted via a flowchart, in accordance with some embodiments of the present disclosure. The method 500 may include validating, by the validation module 206, the re-queue time of the next chunk based on a threshold re-queue time, at step 502. Upon validating the re-queue time, the method may include dynamically modifying, by the modification module 212, a number of the remaining of the set of chunks, at step 504. The step 504 may include steps 506 and 508. The method 500 may include increasing, by the modification module 212, the number of the remaining set of chunks when the re-queue time is greater than the threshold re-queue time, at step 506. The method 500 may include decreasing, by the modification module 212, the number of the remaining set of chunks when the re-queue time is less than the threshold re-queue time, at step 508. The step 506 and 508 are mutually exclusive cases out of which one case may be applicable for the modification of the number of remaining set of chunks based on the comparison.

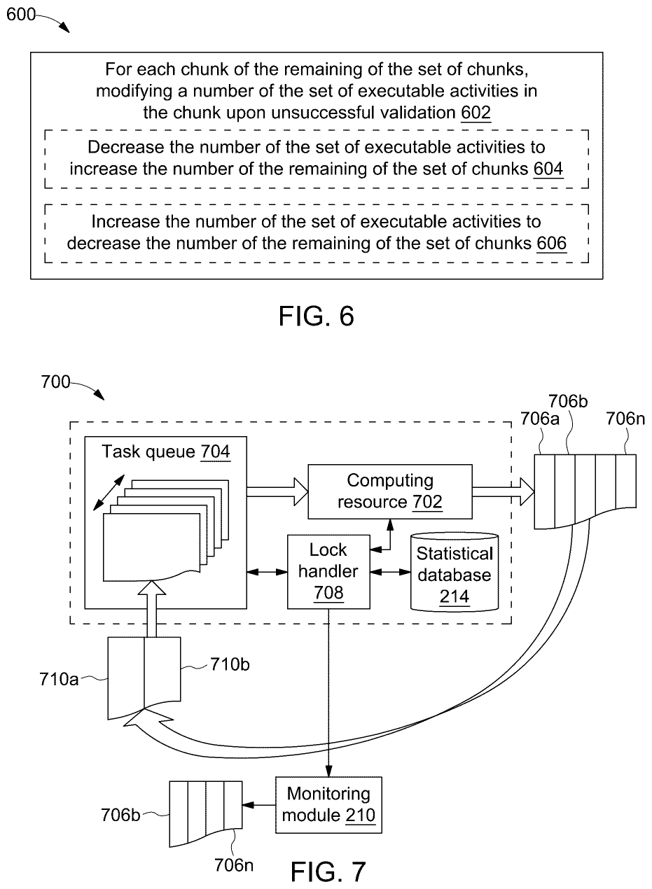

Referring now to FIG. 6, an exemplary method 600 for modifying chunks of a task is depicted via a flowchart, in accordance with some embodiments of the present disclosure. For each chunk of the remaining of the set of chunks, the method 600 may include modifying a number of the set of executable activities in the chunk upon unsuccessful validation, at step 602. The step 602 may include steps 604 and 606. In one embodiment, the method 600 may include decreasing the number of the set of executable activities to increase the number of the remaining of the set of chunks, at step 604. In another embodiment, the method 600 may include increasing the number of the set of executable activities to decrease the number of the remaining of the set of chunks, at step 606. It should be noted that the step 604 and 606 are mutually exclusive embodiments. One of the step 604 and 606 may be applicable based on the requirement of the modification in the number of the remaining of the set of chunks.

Referring now to FIG. 7, a detailed exemplary method 700 for dynamically managing computing resource locking is depicted via a flowchart, in accordance with some embodiments of the present disclosure. The method 700 may identifying a task queue 704 for a computing resource 702 via a lock handler 708. The lock handler 708 may also manage locking and unlocking of the computing resource 702. The task queue 704 may include a set of tasks queued for execution using the computing resource 702 while the computing resource 702 may be in a locked state for execution of a current task.

The lock handler 708 may determine a time limit for which the current task may hold the computing resource 702. The time limit corresponds to a maximum interval of time for which a task (for example, the current task, the next task, or the like) may use the computing resource 702 for execution. Once an execution time associated with the current task exceeds or reaches the time limit, the computing resource 702 may be unlocked for the execution of the next task waiting in the task queue 704. The next task may correspond to a first task in the task queue 704. The lock handler 708 may provide a balance in the waiting time for the set of tasks in the task queue 704 to avoid monopoly of the current task over the computing resource 702. By way of an example, the current task may require the computing resource 702 for 2 minutes for complete execution but the next task waiting in the task queue 704 may require the computing resource 702 for 1 second. The lock handler 708 may send a signal to the chunk generation module 204 to generate a set of chunks by dividing the current task based on a predefined criterion stored in the statistical database 214. The predefined criterion may include at least one of a predefined threshold execution time, a deadline execution time associated with the current task, or a predefined threshold number of tasks in the task queue 704.

It should be noted that in an absence of the task queue 704, the chunk generation module 204 may not be activated to generate the set of chunks. This is because the current task is the only task to be executed, and generating the set of chunks and queuing them in the task queue 704 may waste time since a same task (i.e., the current task) may be acquiring and releasing the computing resource 702 again and again. Apart from the predefined criterion, the statistical database 214 may also include a frequency corresponding to the modification of the number of executable activities of each chunk based on a variance of a re-queue time. In other words, the frequency may correspond to the time interval for which the number of executable activities remains the same in each chunk. A calculation logic for the evaluation of each statistic value may also be stored in the statistic database 214. The statistic value may include, but may not be limited to, the predefined criterion, the frequency, and the variance of the re-queue time.

Upon positive identification of the task queue 704, the chunk generation module 204 may generate ‘n’ number of the set of chunks 706a, 706b, . . . , 706n and may be considered as an output of the computing resource 702. The chunk 706a may correspond to a first chunk and the chunk 706n may correspond to a last chunk of the remaining part of the current task. In one embodiment, upon chunking of the current task, the first chunk 706a may be executed using the computing resource 702 and the remaining of the set of chunks 706b, . . . , 706n may be queued in the task queue 704. Alternatively, each of the set of chunks 706a-706n may be queued in the task queue 704 while the next task may be executed using the computing resource 702.

In some embodiments, the number of the remaining of the set of chunks 706b,. . . , 706n may be modified via the modification module 212 of the monitoring module 210 based on monitoring a re-queue time of a next chunk 706b from the remaining set of chunks 706b, . . . , 706n. The monitoring module 210 may determine the re-queue time of the chunk 706b after execution of the first chunk 706a. The re-queue time may be used as a threshold re-queue time for remaining of the set of chunks (i.e., chunks 706c-706n). The threshold re-queue time may be a current average re-queue time corresponding to the executed chunks from the set of chunks 706a, 706b, . . . , 706n. Thus, the threshold re-queue time may change after each execution of a chunk from the set of chunks.

Upon successful validation (i.e., when the re-queue time of a chunk is less than the threshold re-queue time), remaining of the set of chunks may be modified from the set of chunks 706b, . . . , 706n to modified chunks 710a and 710b. That is to say, if the re-queue time is less than the threshold re-queue time then the number of the set of executable activities may be increased in each chunk in order to increase the size of the chunk due to which the number of the remaining set of chunks may decrease to 2 (i.e., modified chunks 710a-710b). The lesser re-queue time may provide the opportunity to hold the computing resource 702 for a longer time period and timely completion of the current task.

Upon unsuccessful validation (i.e., when the re-queue time of a chunk is more than the threshold re-queue time), the number of the remaining of the set of chunks 706b, . . . , 706n may be increased. That is to say, if the re-queue time is more than the threshold re-queue time, then the number of the set of executable activities may be decreased in each chunk in order to decrease the size of the chunk due to which the number of the remaining set of chunks may increase (not shown). The greater re-queue time may notify for reducing the time period for which the current task is holding the computing resource 702. The modification of the re-queue time may be incorporated to avoid the cases when the re-queue time is not set properly, and is covering the entire task.

The method 700 disclosed above in this figure may be embedded into the Operating System (OS) Lock request standard macro along with a new parameter as a feedback loop information for the task. The method 700 may be used or ignored based on the requirement and based on a build of the program code of the task.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

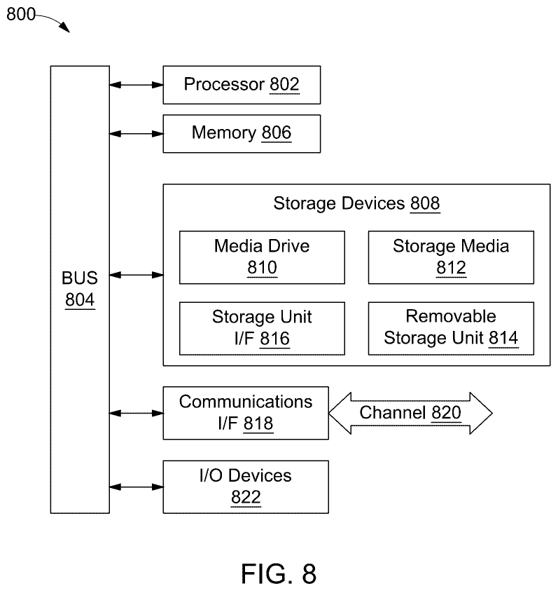

The disclosed methods and systems may be implemented on a conventional or a general-purpose computer system, such as a personal computer (PC) or server computer. Referring now to FIG. 8, an exemplary computing system 800 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 800 may represent, for example, a user device such as a desktop, a laptop, a mobile phone, personal entertainment device, DVR, and so on, or any other type of special or general-purpose computing device as may be desirable or appropriate for a given application or environment. The computing system 800 may include one or more processors, such as a processor 802 that may be implemented using a general or special purpose processing engine such as, for example, a microprocessor, microcontroller or other control logic. In this example, the processor 802 is connected to a bus 804 or other communication medium. In some embodiments, the processor 802 may be an Artificial Intelligence (AI) processor, which may be implemented as a Tensor Processing Unit (TPU), or a graphical processor unit, or a custom programmable solution Field-Programmable Gate Array (FPGA).

The computing system 800 may also include a memory 806 (main memory), for example, Random Access Memory (RAM) or other dynamic memory, for storing information and instructions to be executed by the processor 802. The memory 806 also may be used for storing temporary variables or other intermediate information during execution of instructions to be executed by the processor 802. The computing system 800 may likewise include a read only memory (“ROM”) or other static storage device coupled to bus 804 for storing static information and instructions for the processor 802.

The computing system 800 may also include a storage devices 808, which may include, for example, a media drive 810 and a removable storage interface. The media drive 810 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 812 may include, for example, a hard disk, magnetic tape, flash drive, or other fixed or removable medium that is read by and written to by the media drive 810. As these examples illustrate, the storage media 812 may include a computer-readable storage medium having stored there in particular computer software or data.

In alternative embodiments, the storage devices 808 may include other similar instrumentalities for allowing computer programs or other instructions or data to be loaded into the computing system 800. Such instrumentalities may include, for example, a removable storage unit 814 and a storage unit interface 816, such as a program cartridge and cartridge interface, a removable memory (for example, a flash memory or other removable memory module) and memory slot, and other removable storage units and interfaces that allow software and data to be transferred from the removable storage unit 814 to the computing system 800.

The computing system 800 may also include a communications interface 818. The communications interface 818 may be used to allow software and data to be transferred between the computing system 800 and external devices. Examples of the communications interface 818 may include a network interface (such as an Ethernet or other NIC card), a communications port (such as for example, a USB port, a micro-USB port), Near field Communication (NFC), etc. Software and data transferred via the communications interface 818 are in the form of signals which may be electronic, electromagnetic, optical, or other signals capable of being received by the communications interface 818. These signals are provided to the communications interface 818 via a channel 820. The channel 820 may carry signals and may be implemented using a wireless medium, wire or cable, fiber optics, or other communications medium. Some examples of the channel 820 may include a phone line, a cellular phone link, an RF link, a Bluetooth link, a network interface, a local or wide area network, and other communications channels.

The computing system 800 may further include Input/Output (I/O) devices 822. Examples may include, but are not limited to a display, keypad, microphone, audio speakers, vibrating motor, LED lights, etc. The I/O devices 822 may receive input from a user and also display an output of the computation performed by the processor 802. In this document, the terms “computer program product” and “computer-readable medium” may be used generally to refer to media such as, for example, the memory 806, the storage devices 808, the removable storage unit 814, or signal(s) on the channel 820. These and other forms of computer-readable media may be involved in providing one or more sequences of one or more instructions to the processor 802 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into the computing system 800 using, for example, the removable storage unit 814, the media drive 810 or the communications interface 818. The control logic (in this example, software instructions or computer program code), when executed by the processor 802, causes the processor 802 to perform the functions of the invention as described herein.

Various embodiments provide method and system for dynamically managing computing resource locking. The disclosed method and system may identify a task queue for a computing resource executing a current task. The computing resource may be in a locked state when executing the current task. The task queue includes a set of tasks queued for execution via the computing resource. Upon identifying the task queue, the disclosed method and system may generate a set of chunks from the current task based on a predefined criterion. Each of the set of chunks includes a set of executable activities. Further, the disclosed method and system may execute a current chunk from the set of chunks. Further, the disclosed method and system may queue remaining of the set of chunks for execution by the computing resource after a last task of the task queue upon initiating the execution of the current chunk. Further, the disclosed method and system may monitor a re-queue time of a next chunk from the remaining set of chunks. The re-queue time may be a time interval between completion of execution of the current chunk and initiation of execution of the next chunk.

Thus, the disclosed techniques try to overcome the logical problem for dynamically managing computing resource locking. The techniques may overcome the problem of monopoly of a task on the computing resource and reduce the waiting time for the tasks waiting in the task queue for execution via the computing resource. The techniques may provide a better optimization of the re-queue time by adding dynamicity in the time for which the computing resource is in a locked state. The techniques may further incorporate balancing the number of executable activities in a chunk based on the comparison of the re-queue time with the threshold re-queue time. The techniques may further be adaptive of varying owning time of a task on the computing resource based on the number of tasks in the waiting queue.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has a described method and system for dynamically managing computing resource locking. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for dynamically managing computing resource locking, the method comprising:
identifying, by a processor, a task queue for a computing resource while executing a current task, wherein the computing resource is in a locked state when the current task is executed, wherein the task queue comprises a set of tasks queued for execution using the computing resource;
upon identifying the task queue, generating, by the processor, a set of chunks from the current task based on a predefined criterion, wherein each of the set of chunks comprises a set of executable activities;
executing, by the processor using the computing resource, a current chunk from the set of chunks;
queuing, by the processor, remaining of the set of chunks for execution using the computing resource after a last task of the task queue upon initiating the execution of the current chunk; and
monitoring, by the processor, a re-queue time of a next chunk from the remaining set of chunks, wherein the re-queue time is a time interval between completion of execution of the current chunk and initiation of execution of the next chunk.

2. The method of claim 1, wherein the predefined criterion comprises at least one of a predefined threshold execution time, a deadline execution time associated with the current task, or a predefined threshold number of tasks in the task queue.

3. The method of claim 2, wherein generating the set of chunks from the current task comprises:
receiving at least one of an execution time of the current task or a deadline associated with the current task;
validating execution of the current task based on the predefined criterion, wherein validating comprises, at least one of:
comparing the execution time of the current task with at least one of the predefined threshold execution time or the deadline execution time associated with the current task; or
comparing a number of the set of tasks in the task queue with the predefined threshold number of tasks; and
generating the set of chunks from the current task upon successful validation of the execution of the current task.

4. The method of claim 3, further comprising blocking the generating of the set of chunks upon, one of:
unsuccessfully validating the execution of the current task, or
unsuccessfully identifying the task queue.

5. The method of claim 1, wherein monitoring the re-queue time of the next chunk comprises:
validating the re-queue time of the next chunk based on a threshold re-queue time, wherein the threshold re-queue time is based on a current average re-queue time of executed chunks from the set of chunks; and
upon unsuccessful validation, dynamically modifying a number of the remaining of the set of chunks.

6. The method of claim 5, wherein dynamically modifying the number of the remaining of the set of chunks comprises, one of:
decreasing the number of the remaining of the set of chunks when the re-queue time is less than the threshold re-queue time, or
increasing the number of the remaining of the set of chunks when the re-queue time is greater than the threshold re-queue time.

7. The method of claim 5, wherein dynamically modifying the number of the remaining of the set of chunks comprises:
for each chunk of the remaining of the set of chunks, modifying a number of the set of executable activities in the chunk upon unsuccessful validation, wherein modifying comprises, one of:
decreasing the number of the set of executable activities to increase the number of the remaining of the set of chunks; or
increasing the number of the set of executable activities to decrease the number of the remaining of the set of chunks.

8. A system for dynamically managing computing resource locking, the system comprising:
a processor; and
a memory communicatively coupled to the processor, wherein the memory stores processor-executable instructions, which when executed by the processor, cause the processor to:
identify a task queue for a computing resource while executing a current task, wherein the computing resource is in a locked state while the current task is executed, wherein the task queue comprises a set of tasks queued for execution using the computing resource;
upon identifying the task queue, generate a set of chunks from the current task based on a predefined criterion, wherein each of the set of chunks comprises a set of executable activities;
execute, using the computing resource, a current chunk from the set of chunks;
queue remaining of the set of chunks for execution using the computing resource after a last task of the task queue upon initiating the execution of the current chunk; and
monitor a re-queue time of a next chunk from the remaining set of chunks, wherein the re-queue time is a time interval between completion of execution of the current chunk and initiation of execution of the next chunk.

9. The system of claim 8, wherein the predefined criterion comprises at least one of a predefined threshold execution time, a deadline execution time associated with the current task, or a predefined threshold number of tasks in the task queue.

10. The system of claim 9, wherein to generate the set of chunks from the current task, the processor-executable instructions, on execution, cause the processor to:
receive at least one of an execution time of the current task or a deadline associated with the current task;
validate execution of the current task based on the predefined criterion, wherein validating comprises, at least one of:
compare the execution time of the current task with at least one of the predefined threshold execution time or the deadline execution time associated with the current task; or
compare a number of the set of tasks in the task queue with the predefined threshold number of tasks; and
generate the set of chunks from the current task upon successful validation of the execution of the current task.

11. The system of claim 10, wherein the processor-executable instructions, on execution, further cause the processor to block the generating of the set of chunks upon, one of:
unsuccessfully validating the execution of the current task, or
unsuccessfully identifying the task queue.

12. The system of claim 8, wherein to monitor the re-queue time of the next chunk, the processor-executable instructions, on execution, cause the processor to:
validate the re-queue time of the next chunk based on a threshold re-queue time, wherein the threshold re-queue time is based on a current average re-queue time of executed chunks from the set of chunks; and
upon unsuccessful validation, dynamically modify a number of the remaining of the set of chunks.

13. The system of claim 12, wherein to dynamically modify the number of the remaining of the set of chunks, the processor-executable instructions, on execution, cause the processor to, one of:
decrease the number of the remaining of the set of chunks when the re-queue time is less than the threshold re-queue time, or
increase the number of the remaining of the set of chunks when the re-queue time is greater than the threshold re-queue time.

14. The system of claim 12, wherein to dynamically modify the number of the remaining of the set of chunks, the processor-executable instructions, on execution, cause the processor to:
for each chunk of the remaining of the set of chunks, modify a number of the set of executable activities in the chunk upon unsuccessful validation, wherein modifying comprises, one of:
decreasing the number of the set of executable activities to increase the number of the remaining of the set of chunks; or
increasing the number of the set of executable activities to decrease the number of the remaining of the set of chunks.

15. A non-transitory computer-readable medium storing computer-executable instructions for dynamically managing computing resource locking, the computer-executable instructions configured for:
identifying a task queue for a computing resource while executing a current task, wherein the computing resource is in a locked state while the current task is executed, wherein the task queue comprises a set of tasks queued for execution using the computing resource;
upon identifying the task queue, generating a set of chunks from the current task based on a predefined criterion, wherein each of the set of chunks comprises a set of executable activities;
executing, using the computing resource, a current chunk from the set of chunks;
queuing remaining of the set of chunks for execution using the computing resource after a last task of the task queue upon initiating the execution of the current chunk; and
monitoring a re-queue time of a next chunk from the remaining set of chunks, wherein the re-queue time is a time interval between completion of execution of the current chunk and initiation of execution of the next chunk.

16. The non-transitory computer-readable medium of claim 15, wherein the predefined criterion comprises at least one of a predefined threshold execution time, a deadline execution time associated with the current task, or a predefined threshold number of tasks in the task queue.

17. The non-transitory computer-readable medium of claim 16, wherein for generating the set of chunks from the current task, the computer-executable instructions are configured for:
receiving at least one of an execution time of the current task or a deadline associated with the current task;
validating execution of the current task based on the predefined criterion, wherein validating comprises, at least one of:
comparing the execution time of the current task with at least one of the predefined threshold execution time or the deadline execution time associated with the current task; or
comparing a number of the set of tasks in the task queue with the predefined threshold number of tasks; and
generating the set of chunks from the current task upon successful validation of the execution of the current task.

18. The non-transitory computer-readable medium of claim 17, wherein the computer-executable instructions are further configured for blocking the generating of the set of chunks upon, one of:
unsuccessfully validating the execution of the current task, or
unsuccessfully identifying the task queue.

19. The non-transitory computer-readable medium of claim 15, wherein for monitoring the re-queue time of the next chunk, the computer-executable instructions are configured for:
validating the re-queue time of the next chunk based on a threshold re-queue time, wherein the threshold re-queue time is based on a current average re-queue time of executed chunks from the set of chunks; and
upon unsuccessful validation, dynamically modifying a number of the remaining of the set of chunks.

20. The non-transitory computer-readable medium of claim 19, wherein for dynamically modifying the number of the remaining of the set of chunks, the computer-executable instructions are configured for, one of:
decreasing the number of the remaining set of chunks when the re-queue time is less than the threshold re-queue time, or
increasing the number of the remaining set of chunks when the re-queue time is greater than the threshold re-queue time.
